(19) United States
(12) Patent Application Publication
(10) Pub. No.: US 2014/0069575 A1
(43) Pub. Date: Mar. 13, 2014

(54) APPARATUS AND METHOD FOR GUIDING FILM

(71) Applicant: GED Integrated Solutions, Inc., Twinsburg, OH (US)

(72) Inventors: Scott M. Azzarello, Garfield Heights, OH (US); Roger J. Eberwein, Brunswick, OH (US); Timothy B. McGlinchy, Twinsburg, OH (US); Clifford J. Weber, Richfield, OH (US)

(73) Assignee: GED Integrated Solutions, Inc., Twinsburg, OH (US)

(21) Appl. No.: 14/015,258

(22) Filed: Aug. 30, 2013

Related U.S. Application Data
(60) Provisional application No. 61/697,908, filed on Sep. 7, 2012.

(51) Int. Cl. E06B 3/30

(52) U.S. Cl. CPC E06B 3/30
USPC 156/184; 156/459; 156/378; 156/367

(57) ABSTRACT

An apparatus (400) and method for applying a decorative material to a component. The apparatus comprises a supply roll (70) and a take-up roll (72) fixedly attached to respective first and second fixtures (402, 404). The fixtures are coupled to first and second positioners, (74a, 74b) and are in communication with a controller (300) for adjusting the dispensing roll and take-up roll relative locations to a prescribed position. The apparatus (400) further comprises a support fixture (40) for guiding successive components along a path of travel and guiding decorative material to be applied to a component during operation, the support fixture (405) comprising at least one guide member (408) adjustably attached to a surface of the support fixture, the guide member (408) having at least one limb comprising multiple degrees of selectable freedom for directing the passage of decorative material onto a component during operation.

### CROSS REFERENCES TO RELATED APPLICATIONS

The following application claims priority to co-pending U.S. Provisional Patent Application Ser. No. 61/597,908 filed Sep. 7, 2012 entitled APPARATUS AND METHOD OF GUIDING FILM. The above-identified application is incorporated herein by reference in its entirety for all purposes.

### TECHNICAL FIELD

The present invention concerns decorative coatings for building components.

### BACKGROUND

Components that make a window frame or sash are typically formed by miter cutting extruded components to size before heating the mitered ends and then pressing the heated ends together so that the melted ends bond to each other to form a four sided sash or frame. Further assembly of the window may involve installing an insulating glass “IG” unit into the sash or frame and possibly painting of the plastic that forms the sash or frame. Painting at this stage can be expensive and unnecessarily increase the cost and delivery time of the window or door to the consumer. Decorative patterns can be applied to the window frame or sash prior to cutting of the component into pieces for assembly. These decorative patterns could either be a solid color or could simulate a wood grain finish.

One prior art machine, sold by CPS Resources of Indian Trail, N.C. 28079, routes substrates such as picture frames past a flexible foil or film dispensing head. The speed of movement of the substrate matches the unwinding speed of the film as the film is brought into contact with the substrate. A combination of heat and pressure treatment of the film as it contacts the substrate causes the film to permanently adhere to the substrate. The present invention relates to improvements to this process especially as the process relates to application of decorative film or foil to window or door components that have variable profile shapes.

### SUMMARY

This disclosure relates to apparatus and method for applying a decorative material to specified surfaces of a component. In one application, subsequent to the application of the decorative material, the component is cut and assembled to form a window or door frame or sash. In one embodiment, multiple decorative film application stations are staged to apply a decorative film to different surfaces of the component.

A controller in communication with each of the multiple decorative film application stations executes a control program for coordinating feeding of the component from one station to a next subsequent station. The control program executed by the controller also changes and controls a set up of each of the multiple stations for the profile to receive the decorative material by means of an intuitive user interface.

In an exemplary embodiment, each film application station has a support for the component (typically a vinyl lineal of a certain length) having an input and an output side. A drive moves successive elongated components along a path through the application station from the input side to the output side as a transfer film is applied to a surface of the component. A properly positioned and oriented transfer head applies heat and pressure to the transfer film as the component moves through the application station. The disclosed system accommodates different style and shape components corresponding to different style windows frames, sashes, or door frames. A backing fixture is configured to support a given component profile, which is positioned to support the component as the component moves through the application station in a region of the transfer head.

In the exemplary embodiment, a controller presents to a user on a computer monitor a menu of different components having different profiles for transfer film treatment. The user chooses a particular component from the menu and the controller identifies a proper recipe for use at each of the multiple work stations.

The recipe includes one or more of the following treatment parameters: a proper choice for the heat and pressure roller at each application station, a proper backing fixture for the component as the component moves through an application station, an angle of approach for contact between the component and the a transfer head, a radial position of the transfer head with respect to an application surface of the component during movement of the component through an application station, a target speed of movement of the component through the application station, a target temperature for the roller, and a film width for application at each of the multiple application stations. In the exemplary embodiment, the user selects and installs the roller and backing fixture and film at each station and the controller through means of communication with each station performs automated control and/or monitoring of the other parameters.

Another exemplary embodiment of the present disclosure comprises an apparatus and method for applying a decorative material to at least one surface of a component. The component can then be cut and assembled to form part of a window or door. The apparatus comprises a supply roll and a take-up roll fixedly attached to respective first and second fixtures. The fixtures are coupled to first and second positioners, and are in communication with a controller for adjusting the dispensing roll and take-up roll relative locations to a prescribed position. The apparatus further comprises a support fixture for guiding successive components along a path of travel and guiding decorative material to be applied to a component during operation, said support fixture comprising at least one guide member adjustably attached to a surface of said support fixture, said guide member having at least one limb comprising multiple degrees of selectable freedom for directing the passage of decorative material onto a component during operation.

While another exemplary embodiment of the present disclosure comprises a system for applying decorative material to at least one surface of component used in the assembly of a window or door. The system includes a supply roll and a take-up roll fixedly attached to respective first and second fixtures. The fixtures being coupled to first and second positioners. The first and second positioners are in communication with a controller for adjusting the dispensing roll and take-up roll relative locations to a prescribed position. The system also includes a transfer head for applying heat and pressure to the decorative material during operation, the transfer head is coupled to superior first and superior second positioners, the superior first and superior second positioners are in communication with the controller for adjusting the transfer head location to a prescribed position. The system also comprises at least one of the the first and second positioners being selectively connected to at least one of the superior first and superior second positioners by a link and an interchangeable support fixture for guiding successive components and decorative material during operation along a path of travel, the support fixture comprising at least one guide member fixedly attached to a surface of the support fixture, the guide member having at least one limb comprising multiple degrees of selectable freedom for directing the passage of decorative material onto a component during operation.

Yet another example embodiment of the present disclosure comprises a method of applying decorative material to a component used to make windows and/or door assemblies. The method comprises the steps of selecting a recipe from a controller based on the profile or type of component receiving the application of decorative material during operation and selectively locating a supply roll coupled to a first rotational positioner and selectively locating a take-up roll coupled to a second rotational positioner based on the recipe stored in the controller. The method also comprises inserting a removable support fixture based on the recipe, the support fixture for guiding successive components and decorative material during operation along a path of travel and fixedly attaching at least one guide member to a surface of the support fixture, the guide member having at least one limb comprising multiple degrees of selectable freedom for directing the passage of decorative material onto a component during operation.

Another example embodiment of the present disclosure comprises a supply assembly for selectively locating the application of decorative material to a component used in to make windows and/or door arrangements as the components move along a path of travel corresponding to a first direction. The supply assembly comprises a supply roll having first and second supply reels rotatably located on an adjustment sleeve, the supply roll for supporting decorative material applied in line along the first direction and onto a window or door arrangement during operation. The supply assembly further comprises an adjustment rod passing through the adjustment sleeve and supply roll reels. The adjustment rod includes a selectively rotatable nut at a first end of the adjustment rod that engages the adjustment sleeve for the selectable location of the supply roll and adjustment sleeve to a desired position along a second direction. The supply assembly also comprises a biasing member enveloping a second end of the adjustment rod, the biasing member controlling the selectable location of the supply roll and adjustment sleeve along the second direction for selectable alignment of the supply roll's dispensing of decorative material applied to a window or door arrangement during operation.

These and other advantages and features of the invention will become better understood by reference to the accompanying more detailed description, which is described in conjunction with the accompanying drawings.

### BRIEF DESCRIPTION OF THE DRAWINGS

FIGS. 1 and 2 are perspective depictions of a film application system constructed in accordance with an exemplary embodiment of the invention;

FIG. 3 is a perspective view of two abutting window parts that have been cut from a lineal and heat fused to form a window frame or sash;

FIG. 3a is an end view of a component showing different surfaces to be treated by a transfer film;

FIG. 4 is a perspective view of a single workstation for applying flexible film to an elongated component;

FIG. 5 is an enlarged front view of the workstation of FIG. 4;

FIGS. 6 and 7 are enlarged end views of the two successive workstations for sequential treatment of elongated window parts;

FIGS. 8-10 are perspective views of a single workstation shown a tape or film application zone or region in greater detail;

FIG. 9A is an enlarged perspective view of the film application region of FIG. 9;

FIGS. 11a and 11b are schematic depictions showing alternate backing fixtures for use with different configuration profiles of the elongated window or door components;

FIG. 12 is a schematic block diagram of a control system for controlling the exemplary decorative tape application system;

FIG. 13 is a perspective view of an apparatus or system for applying a decorative material to at least one surface of a component in accordance with one example embodiment of the present disclosure;

FIG. 14 is a front view of the example embodiment of FIG. 13;

FIG. 15 is an end view of the example embodiment of FIG. 13;

FIG. 16 is a perspective view of the example embodiment of FIG. 13, illustrating a magnified region;

FIG. 17 is a magnified perspective view of the magnified region of FIG. 16;

FIG. 18 is a sectioned plan view of FIG. 14 along section lines 18-18;

FIG. 19 is a sectioned perspective view of FIG. 14 along section lines 19-19;

FIG. 20 is a perspective view of a support fixture in accordance with one example embodiment of the present disclosure;

FIG. 21 is the support fixture of FIG. 20, illustrating the decorative material path in accordance with one example embodiment of the present disclosure;

FIG. 22 is a perspective view of a support fixture in accordance with another example embodiment of the present disclosure;

FIG. 23 is a front elevation view of FIG. 22

FIG. 24 is a side elevation view of FIG. 22;

FIG. 25 is a block diagram illustrating a method for applying decorative material to a component in accordance with one example embodiment of the present disclosure; and

FIG. 26 is a perspective view of a supply assembly constructed in accordance with one example embodiment of the present disclosure; and

FIG. 27 is a side elevation view of the supply assembly of FIG. 26.

### DETAILED DESCRIPTION

The drawings depict an application system 10 for applying a decorative material (F) such as transfer foil or film coating to selected surfaces of a workpiece. The decorative material F includes in one example embodiment, an ink component over backing material and may or may not include a metal within the substrate of component.

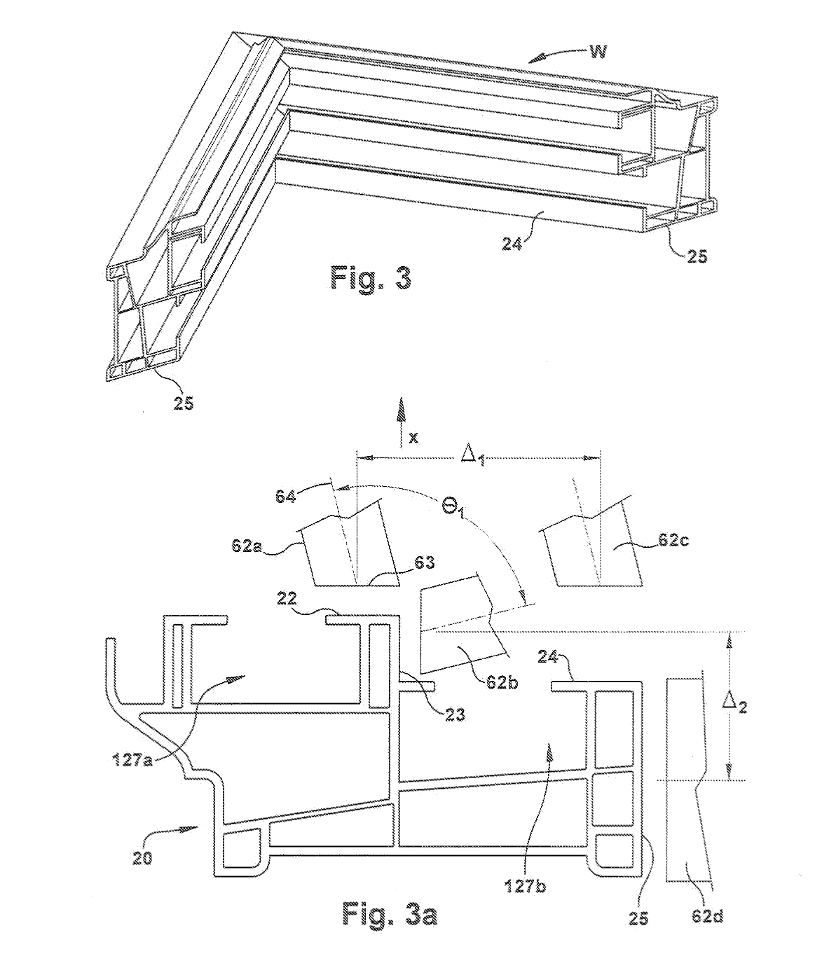

In one exemplary embodiment, the workpiece is a lineal 20 which is cut and that used to construct a window or door frame or sash. The system 10 applies a transfer film F to multiple surfaces 22-25 (See FIG. 3a) of the elongated component which is then cut and assembled into a window or door such as the window frame W shown in FIG. 3. Such components are referred to herein as lineals.

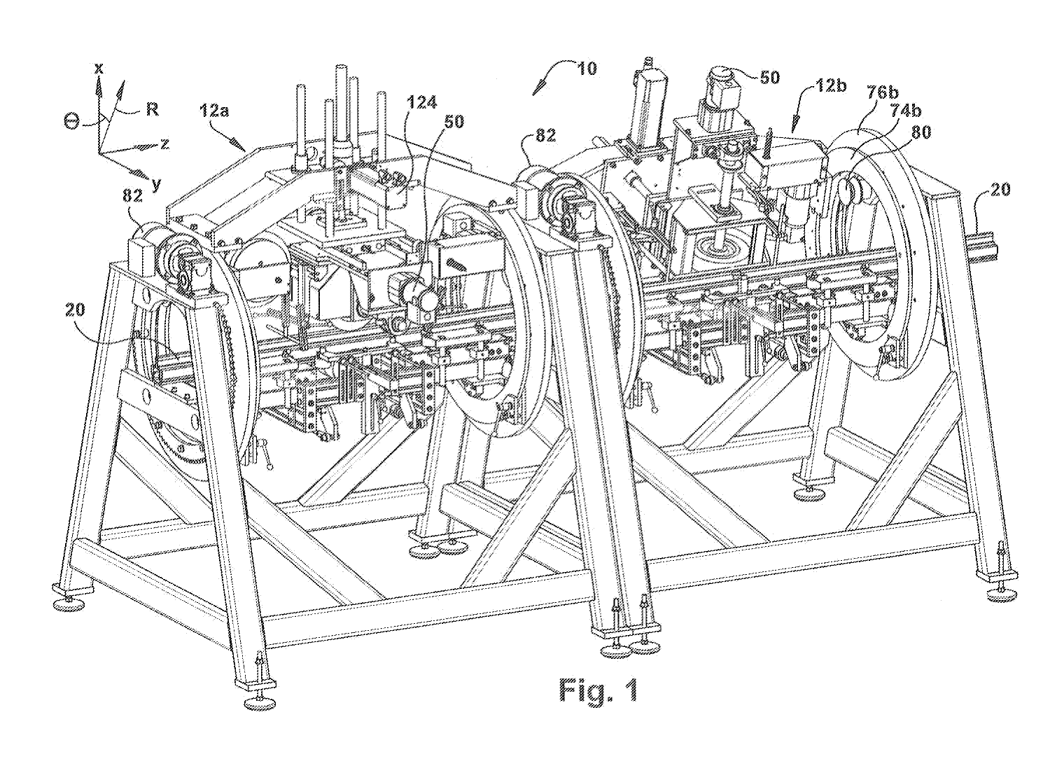

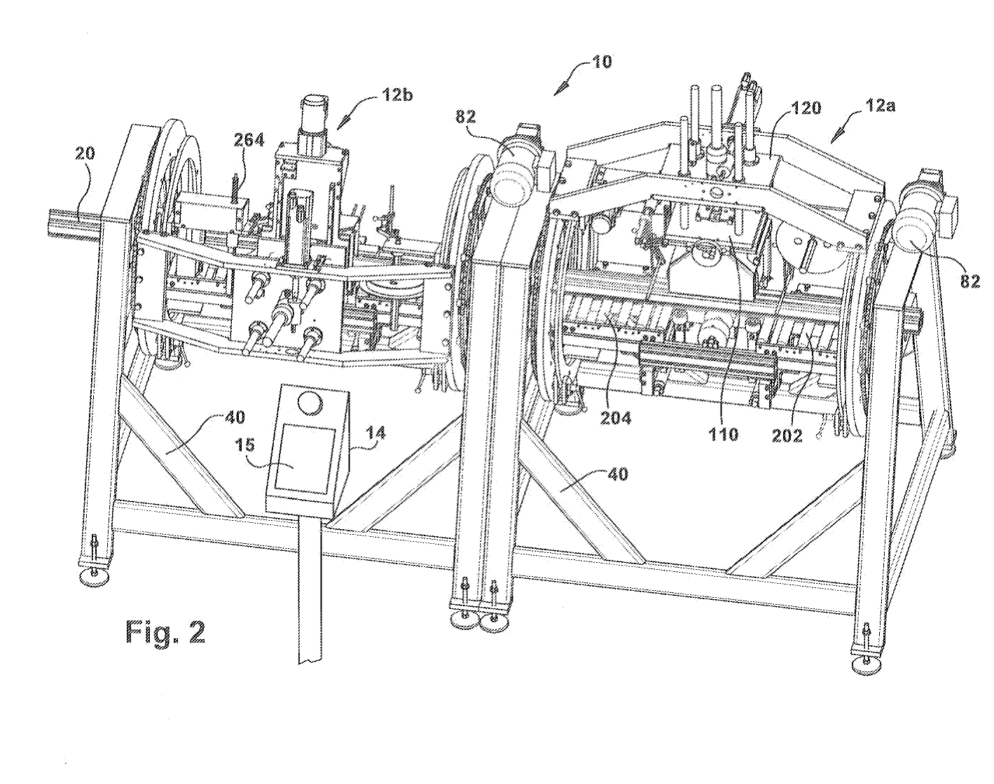

One Exemplary system 10 includes multiple decorative transfer film application stations or work stations wherein each station applies a decorative material to different surfaces or regions of the lineal. In FIGS. 1 and 2, two such stations 12a, 12b are depicted. Generally, each station applies a transfer film F to a specified exposed region of the elongated component so that each next subsequent station in a series of such stations covers a different exposed region until a desired portion of the lineal has been covered with the film F. Turning to FIG. 3a, for example, the surfaces 22-25, of the component 20 are covered with film F in one pass of the component or lineal through four different film applying workstations. An untreated lineal enters the first work station and all desired surfaces have been covered when the component leaves the last work station.

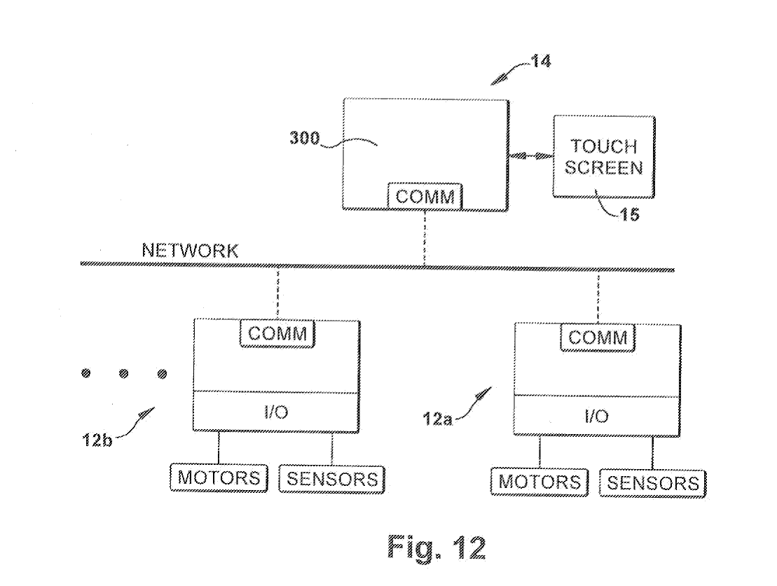

The multiple work stations operate under control of a control station 14. A programmable controller 300 (FIG. 12) at the control station 14 communicates with each of the work stations to control treatment of the lineal as it moves through the multiple work stations. An executable control program that runs at the control station 14 manages set up of the work stations to accommodate application of a specified width film to different surfaces of a lineal having a specified profile at the different work stations. As discussed in more detail below, appropriate set up at each work station involves controlled movement of a transfer head 60 of the work station before the work station can accommodate a particular profile of lineal 20. As used throughout, the term “profile” means the cross sectional shape of the lineal 20 such as the shape of the end view of FIG. 3a. It should be appreciated by one skilled in the art that although only one profile is shown in FIG. 3a, a large number of different profiles may receive decorative films on specified surfaces and indeed the flexibility to rapidly set up the system to accommodate a range of different profiles in one advantage of the exemplary system.

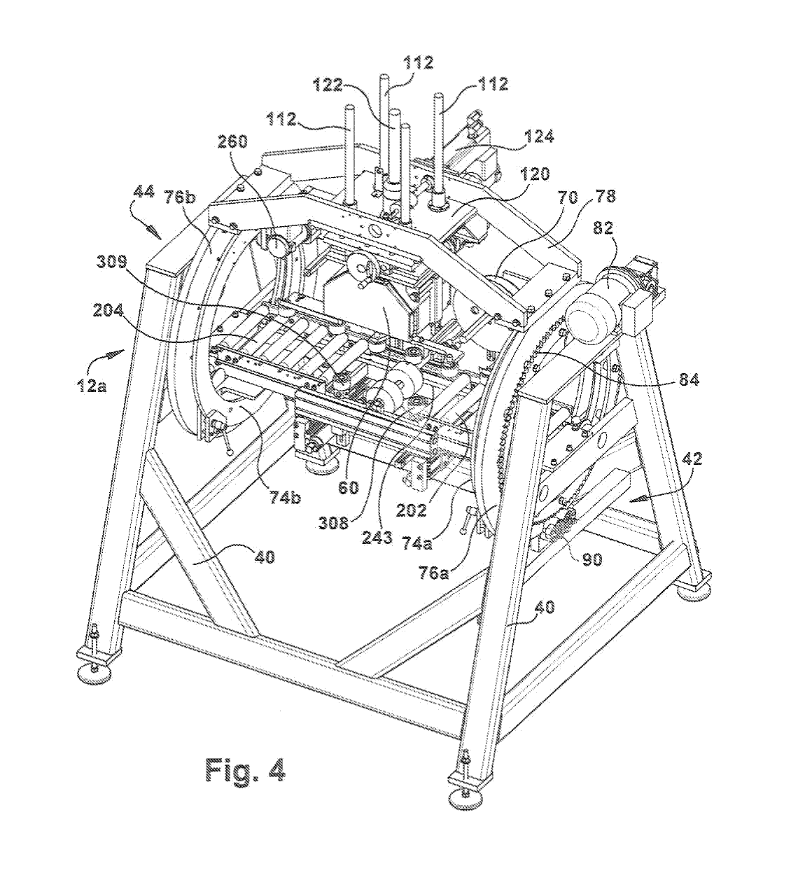

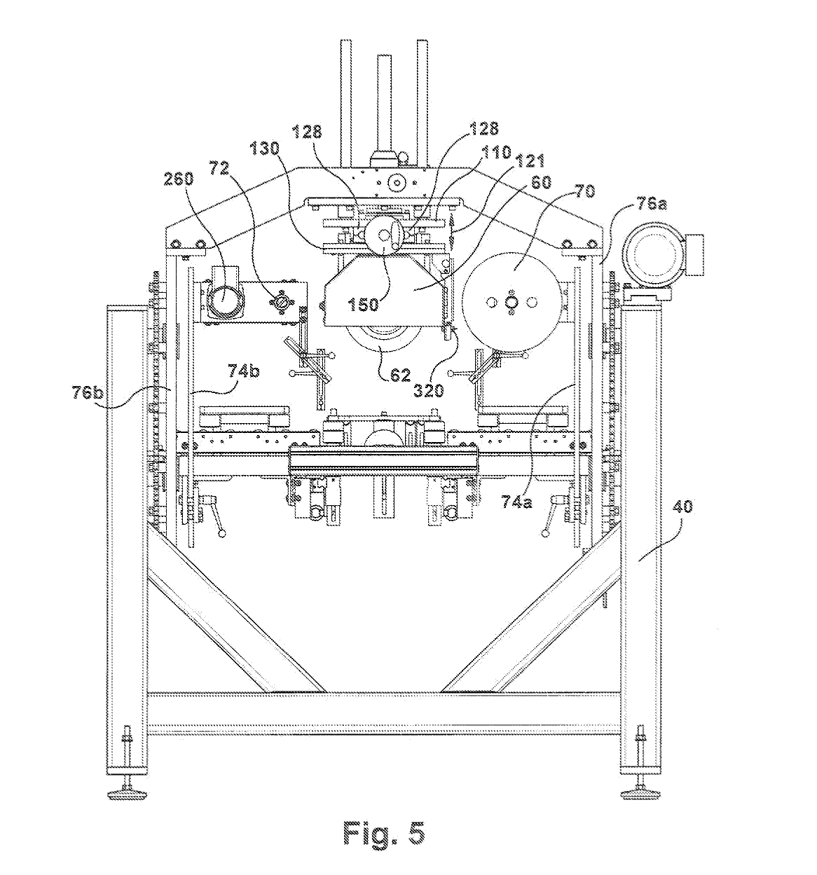

A single film application work station 12a is shown in FIG. 4 and is seen to include a support or stand 40 having an input side 42 and an output side 44. A drive 50 which in one exemplary embodiment is an electric motor moves successive lineals 20 (FIG. 2) along a generally linear path through the work station 12a from the input side to the output side as a thin layer of transfer film F is applied to a surface of the lineal. A transfer head 60 includes a rotatably mounted drive roll 62 (FIG. 5) coupled to the drive 50. In addition to moving the elongated component, the drive roll 62 applies heat and pressure to the transfer film F as the lineal 20 moves through the film application station 12a from the input side 42 to the output side 44. Motive force for moving the component is applied by the roll 62 but the roll does not directly contact the component due to the presence of the transfer film F between the drive roll and the lineal.

The exemplary film material is an elongated multi-layer plastic film wherein one layer of the multilayer material is the decorative layer and a second layer is a backing layer B that is recoiled after application of the decorative layer to the lineal 20. Additional formulations of the film include a cover layer and possibly a separate adhesive layer for fixing the decorative layer to the lineal 20. In a typical operation application of heat and pressure with the film F in contact with the lineal causes the decorative layer to bond to the lineal and the backing material separates from the cover layer (if present) and is wound about a takeup roll. Suitable films F for use with the exemplary embodiment of the invention are commercially available from CPS Resources of Indian Trail, N.C. 28079.

Lineals are extruded with a variety of different cross sectional shapes or profiles. Each of the multiple work stations e.g. 12a and 12b utilizes a backing or support fixture that is specifically designed to support the profile of a specific lineal as the lineal moves through the work station past the transfer head 60 and its drive roll 62. A typical lineal 20 can be over 20 feet in length and multiple pieces are cut from such a lineal after the material or film F is applied. A spacing between successive drive rolls 62 at two adjacent, successive workstations is less than the length of the lineal. Therefore, before the trailing edge of a lineal moves out of driving engagement with one roll 62 (at a first workstation for example) it's leading edge passes or drivingly engages a downstream roll 62 at a next subsequent film application workstation. A transmission between an output of the drive 50 and the roll 62 includes a slip clutch. Use of such a clutch allows the motors of the two (or more) drives to rotate at slightly different speeds so that the fastest motor determines speed of movement of the lineal.

The transfer head 60 applies film from different angles with respect to a center axis of component movement through each station. The control station 14 includes a touch sensitive input screen 15 that transmits signals to the programmable controller 300 and allows a user or operator to choose a component profile from a menu of such profiles (See FIG. 12). Examples of the head 60 (and its associated roller 62) approaching the lineal 20 from different angles is illustrated by reference to FIG. 3a. A surface 22 of the elongated component is covered at a first of multiple successive stations using roll 62a (See FIG. 3a) having a beveled outer surface 63. If the surface 22 is generally parallel to a floor on which the workstation stand 40 rests, the angular spacing or offset of a centerline 64 to the vertical (x axis in FIG. 3a) is less than 15 degrees. The beveled surface 63 of the drive roll 62a contacts a generally flat surface 22 (with of course the film F interposed there between).

A similarly configured roll 62b is used (at a later application station) to treat the surface 23 which is seen to be oriented at a right angle with respect to the surface 22. An angle θ₁ between the centerline 64 of the roll is ninety degrees. Two other different configuration rollers 62c, 62d for treating the surfaces 24, 25 are depicted in FIG. 3a and these rollers 62c, 62d would be positioned at two additional downstream stations in the system 10. During set up of system, the user chooses an appropriate drive roll from an inventory of such rolls. The drive roll is keyed and mounts to a correspondingly keyed shaft. The shaft also supports two collars (not shown) which limit side to side movement of the drive roll along the length of the shaft after the roller is properly positioned on the shaft.

In describing the operation of the various components of the film application stations (e.g. 12a and 12b), it is useful to define a co-ordinate system such as the co-ordinate system shown in FIG. 1. A distance along the path of travel of the elongated component is a distance along the z direction from an origin of the co-ordinate system where the component enters the first workstation 12a. A distance in a radial direction from the z axis of this system is designated as a distance R. Finally, the angular position of a location with respect to the a vertical (perpendicular to the floor the stand 40 rests upon) is referred to by an angle theta θ.

Controlling the Angle of Tape Application

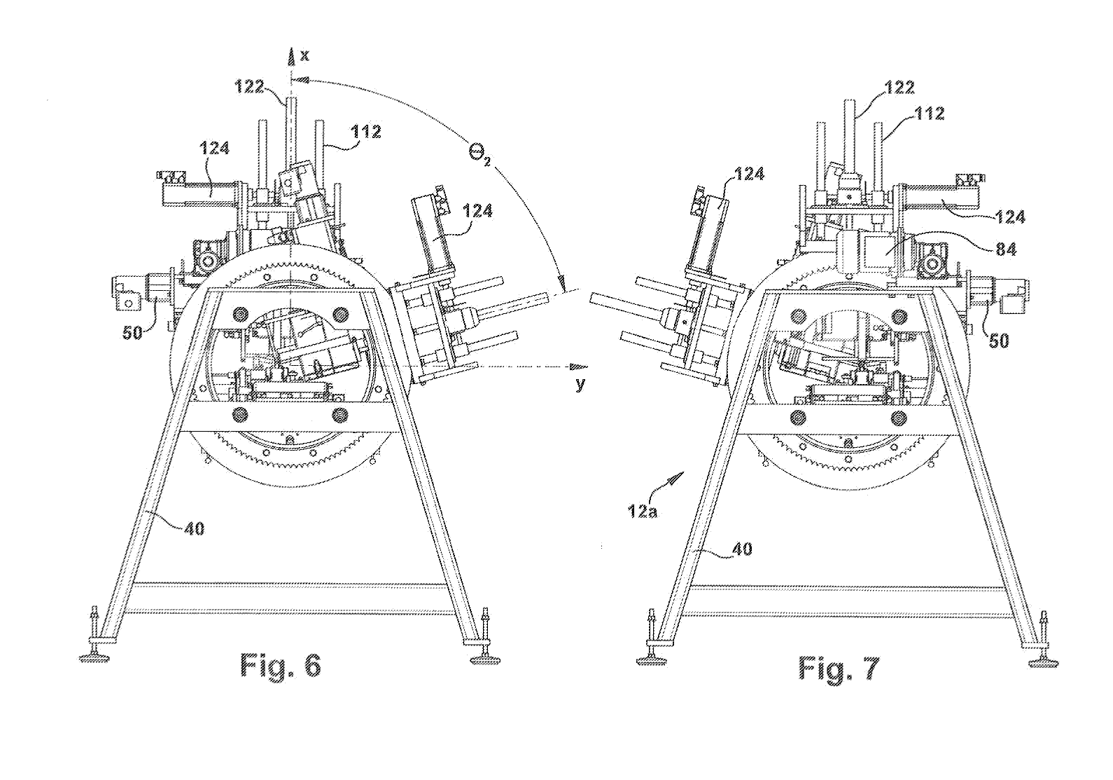

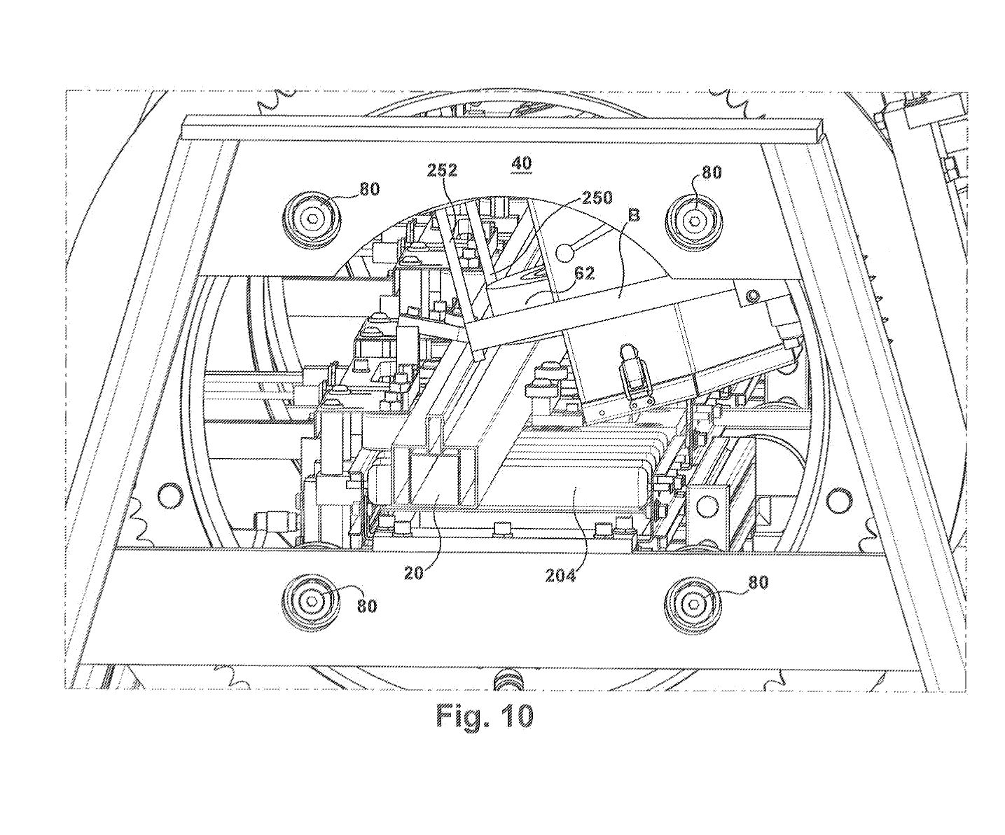

In one exemplary embodiment, a dispensing roll 70 and a take-up roll 72 are mounted to first and second rotatably mounted rings 74a, 74b. The dispensing roll 70 is mounted to a ring 74a on the input side 42 of the workstation and the take up roll is mounted to a ring 74b on the downstream or exit side 44 of the workstation. The transfer head 50 (including its pressure backing roll 62) is mounted to a cross piece 78 that extends between two larger support rings 76a, 76b rotatably supported by the stand at an input and an output of the workstation (See FIG. 4). The rings 76a, 76b are mounted to the stand 40 by means for four spaced apart cam followers 80 (See FIG. 10). A drive motor 82 supported by the stand 40 rotates the rings 76a, 76b (under control of the controller 300) to orient the transfer head 76 with respect to the path of travel the lineal follows along the z axis. As an example, the head 60 has been oriented at two different orientations spaced by an angle θ₂ at two successive work stations in the end view of FIGS. 6 and 7. The presently preferred drive 82 is an a.c electric motor having an output shaft that rotates a drive belt (not shown), which engages a circumferentially extending gear 84 connected to the ring 76a. Use of a servo drive motor is a possible alternate for use with the disclosed system for controllably rotating the rings 76a, 76b. Due to the rigid coupling together of the rings 76a, 76b by the cross piece 78 the rings 76a, 76b rotate together whenever the motor 82 is energized.

During set up of the application system 10, the controller instructs the operator regarding relative positioning of the smaller, inner rings 74a, 74b relative to the outer support rings 76a, 76b. In many applications, the rings 74a, 74b are oriented so that the film unwinds from the supply, passes into engagement with the roller 62 and the backing is rewound all within the same plane as the roller 62 with no angular offset. Other set ups for different component profiles require relative angular offset of one or both of the supply 70 and take up 72 rolls with respect to the head 60 and its drive roller 62. This angular offset of the coil and roll can be up to 45 degrees. As a specific example, the transfer head is oriented directly above the lineal passing through the work station and both the ring 74a on the input side supporting the dispensing roll and the ring 74b on the output side support the take up roll are rotated in a counterclockwise sense as seen in FIG. 1 by an angle of 30 degrees.

To re-orient (if needed) the rings 74a, 74b (and attached rolls) with respect to their support rings 76a, 76b the user releases a brake 85 comprising a plate carried by the ring 76a (for example) by loosening a lever arm 86 which lessens the frictional contact between the brake and the ring 74a (for example). The inner rings 74a, 74b are mounted to their respective outer rings 76a, 76b by bearings which allow relative rotation of the ring 74a (for example) with respect to the ring 76a. Once an appropriate angular offset is set by the user rotating the ring 74a for example, the user retightens the brake 85. Note, in one orientation wherein the rolls and drive roller are essentially co-planer (most common) a pin slips into aligned holes on the rings 76a, 74a (not shown) to supplement the action of the brake 85. In all situations, the rings 74a, 74b are fixed to their respective support rings 76a, 76b when the motor 82 is actuated to rotate the head 60. In one exemplary embodiment, the system 10 has a automatic brake 90 supported by the stand 40 for stopping the rotation of the ring 76 in response to the controller 300 to lock the rings 76a, 76b in relation to the stand and to each other once they have been properly oriented during set up of the system. The exemplary brake 90 is a commercially available brake having a pneumatically actuated brake shoe and is sold by Tolomatic.

Radial In and Out Movement of the Transfer Head

The transfer head 60 is mounted to a generally planar support plate 110 (FIG. 5) for radial movement in and out with respect to the z axis. The plate 110 is coupled to four linear shafts 112 which pass through bearings supported by a generally planar plate 120 supported by the cross piece 78 a fixed distance from the z axis or path of lineal travel. In and out radial movement of the transfer head is achieved by changing a separation of the two plates 110, 120 indicated by the arrow 121 in FIG. 5.

Mounted to the radially fixed plate 120 is a mechanical jack screw 122 having a shaft that connects to the support plate 110. An electric motor 124 has an output coupled by means of a coupling to the jack screw 122 for relative radial movement of the support plate 110 with respect to the radially fixed plate 120. The distance separation between the two plates 110, 120 varies depending on the profile of the lineal 20. The controller 300 is programmed with the correct distance or separation for each of the transfer heads of the multiple workstations so that for a given lineal 20 the setup of this spacing is accomplished in an automated fashion by sending appropriate energization signals to the various motors for controlled radial position of the head 60.

Side to Side Movement of the Transfer Head.

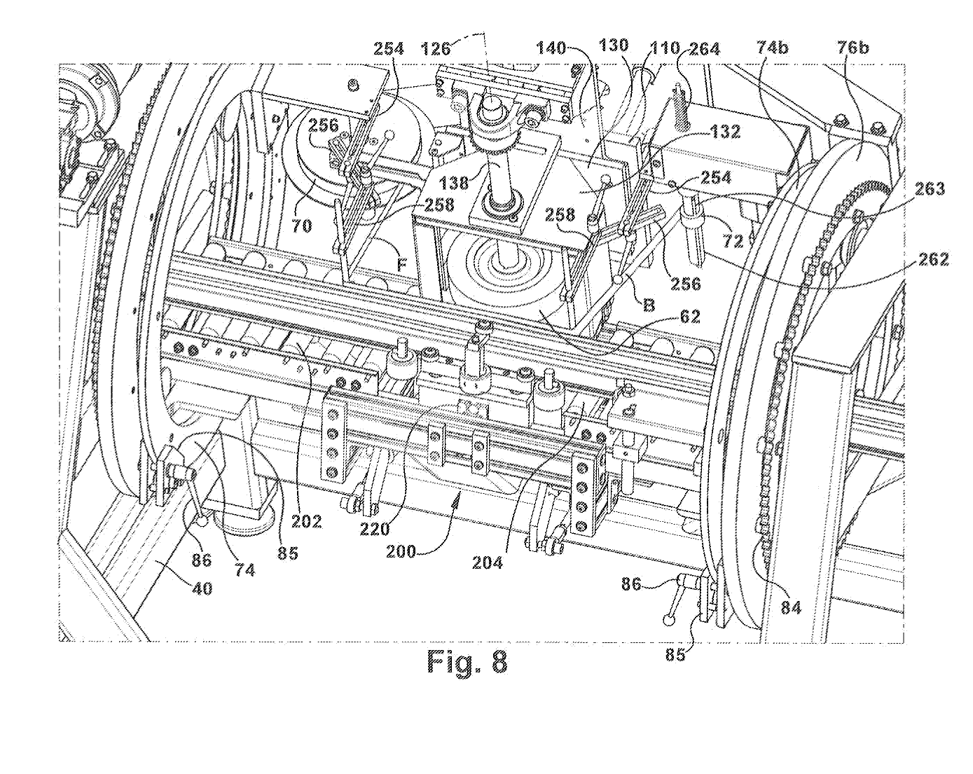

The drive roll 62 is mounted for rotation about an axis 126 (See FIG. 8) transverse to the z axis and which changes depending on what surface of the lineal is to be treated with film. In some applications it is necessary to move the tangential position of the roll 62. This need is illustrated in the schematic depiction of FIG. 3b which shows a lineal suitable for fabrication into a double hung window frame supporting two sashes in gaps or channels 127a, 127b. Consider the two pressure rolls 62a, 62c depicted in FIG. 3b. The first roll 62a presses the film F against a generally planar surface 22 of the lineal 20 and has a beveled outer surface for pressing the film against that surface. Now consider the roll 62c. This roll (supported at a different work station from the roll 62a) also has a beveled surface for pressing the film against a conforming surface 24 of the lineal 20. An axis of rotation for the two rollers 62a, 62c are similarly oriented as determined by the angular rotation of the head about the z axis. The plane in which the two rollers 62a, 62c rotate, however, is offset by distance delta Δ₁. This offset is achieved by moving one of the rolls 62a, 62c with respect to a nominal position for the roller. In a similar way, it is seen that the plane of rotation of the two rollers 62b, 62d are offset by a distance Δ₂. (Note, these two rollers also indicate the need for an different angular offset of the transfer head for different treatment surfaces).

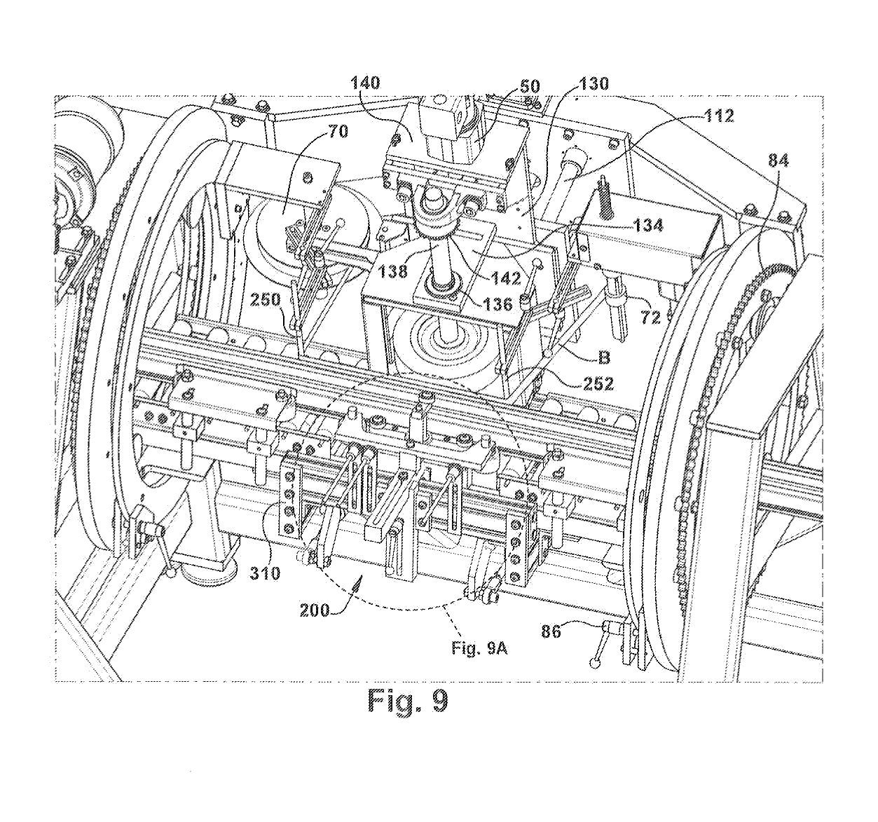

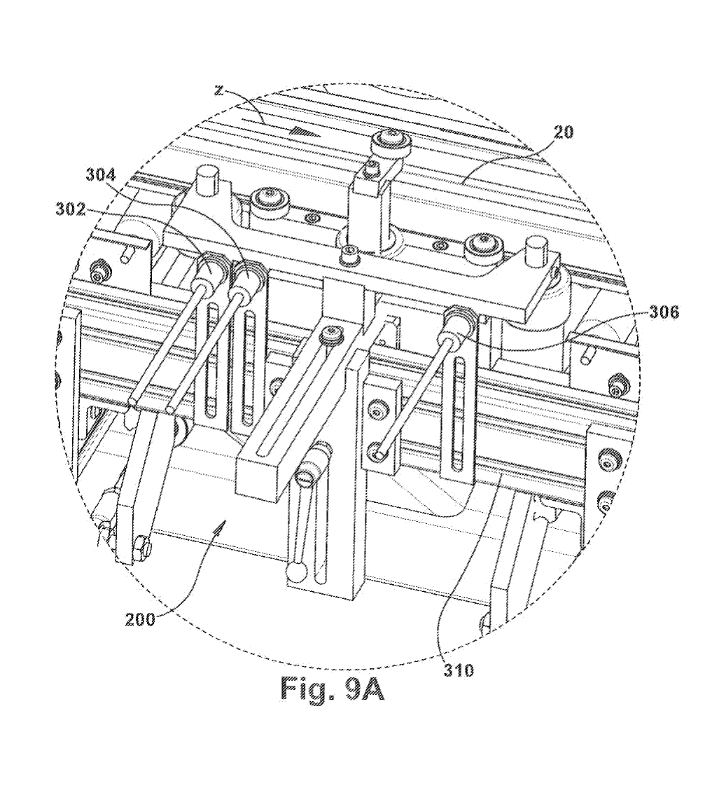

To achieve such side shifting of the roll, the plate 110 includes two side by side linear rails or bearings 128 that support an insulating plate 130 supported by those bearings (See FIG. 5). The plate 130 moves in a linear path with respect to the plate 110. As seen in FIGS. 8 and 9, a housing or oven 132 partially encloses the roller 62. A flange 134 supports a bearing 136, which supports a roller drive shaft 138 for rotation. During set up of a workstation an appropriately configured roller 62 (in a preferred embodiment constructed from silicone) for a particular lineal having a particular profile is attached to the roller drive shaft 138. A motor mounting plate 140 is coupled to the plate 130 and supports the drive motor 50. An output shaft (not shown) of the motor is coupled by means of a drive to a gear 142 attached to the roller drive shaft, as shown in FIG. 9.

In the present example, side shifting of the oven 132, roller 62 and drive 50 is achieved by a user rotating a manual crank 150. Rotation of the crank in one sense moves the roller 62 in one direction and rotation in an opposite sense moves the roller in an opposite direction. In the exemplary embodiment the hand crank 150 is coupled to a ball screw drive having acme threads. In an alternate example embodiment, side shifting is achieved by a motor/servo drive directed by the controller 300.

Backing Fixtures

The enlarged depictions of FIGS. 8, 9, 9A, and 10 illustrate a film transfer zone or region 200. The film F and the elongated component or lineal 20 enter this zone and come in contact with each other as the roll 62 applies pressure and heat to transfer a decorative layer of the film F to a surface of the lineal 20. Before making contact with the film F in the transfer zone, the lineal 20 is supported by a series of parallel, generally horizontal entrance rolls 202. After transfer of the decorative layer to an appropriate surface of the lineal 20, the lineal is supported by a series of parallel, generally horizontal exit rolls 204. In between these rolls, in a region of transfer each workstation includes a specially configured backing fixture.

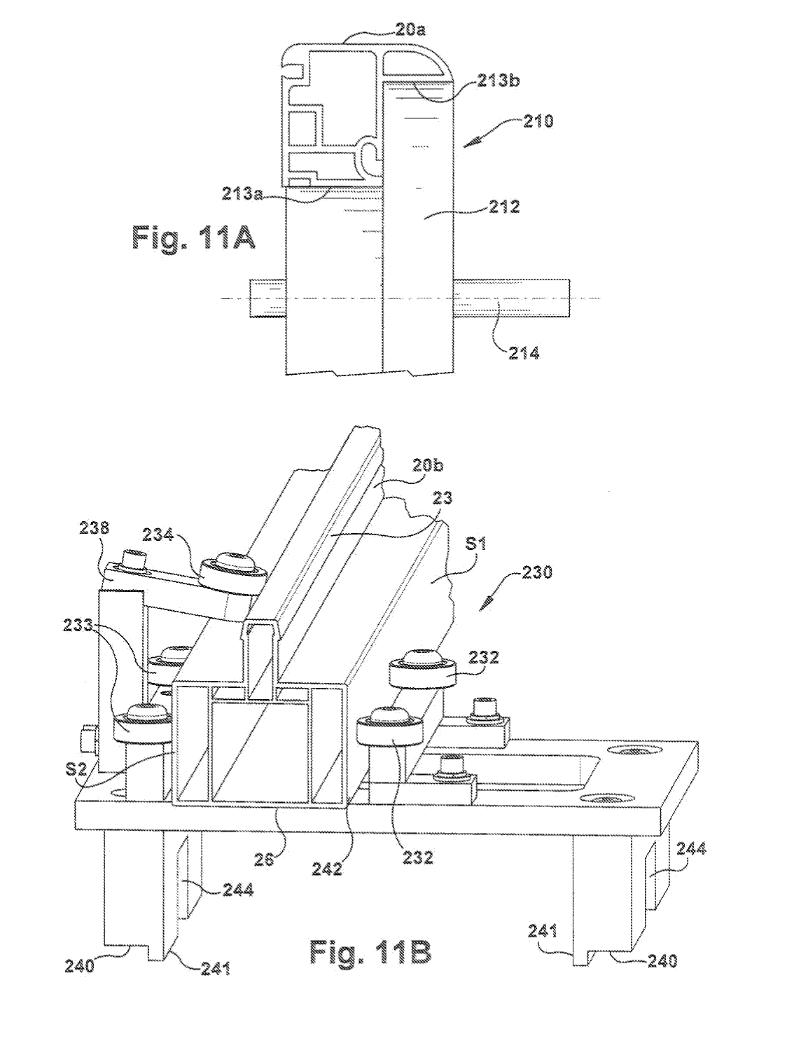

The exemplary system 10 can accommodate many different configuration lineal profiles. FIGS. 11A and 11B depict two end views of lineals 20a, 20b having different shapes. In addition to requiring different configuration rolls 62, the variety of different shaped lineals must be adequately supported and guided in the transfer region 200 as film is pressed against a surface of the lineal to be treated. FIGS. 11A and 11B depict two different backing fixtures 210, 230 that support and guide the lineals 20a, 20b. Note, each of the multiple stations 12a, 12b etc through which the lineal moves has its own backing fixture, which are not necessarily the same from one work station to the next.

A first backing fixture 210 (FIG. 11A) includes a stepped backing roll 212 having two different diameter outer lineal support surfaces 213a, 213b. The stepped roll 212 is coupled to an axle 214 having a length to fit in and be rotatably supported by trunnion bearings 220 (FIG. 8) mounted to the stand 40 on opposite sides of the transfer region or zone 200. During set up of the workstation, the controller 300 displays to the user a number (perhaps hundreds) of lineals by a designation and then prompts a user to select from an inventory of backing fixtures and rollers 62 so that an appropriate combination of roller and backing fixture is used at each work station 12a, 12b etc. In an instance in which the fixture 210 of FIG. 11A is appropriate, the user fits the axle 214 into the bearings 220 so that the desired lineal of the many possible profiles can pass through the zone 200 in contact with the backing fixture in a manner depicted in FIG. 11A.

The backing fixture 230 is specially configured for a lineal 20b having a flat surface 26 spaced away from the roller 62. The lineal 20b enters the zone 200 supported by the entrance rolls 202 and passes through the backing fixture 230 and in particular passes over two flat support surfaces 242 of the fixture that define a spacing to appropriately position a top of the lineal for contact with the pressure roller 62. A first pair of sidewall guide rollers 232 engage one side wall S1 of the lineal and an opposite pair of side guide rollers 233 engage an opposite side wall S2 of the lineal. An additional guide roller 234 engages a surface of the lineal from one side. The side to side spacing of the rollers 232, 233 is adjustable so that the fixture can accommodate different width lineals. The angle of an arm 238 that supports the roller 234 is also adjustable to contact the lineal at different angles.

During set up, the fixture 230 is placed by an operator into a rectangular gap or space between the entrance and exit rollers 202 204. Four guides 241 fit down into this gap so that four downwardly facing surfaces 240 of the fixture abut a perimetrically extending rectangular border or ledge 243 that surrounds the rectangular gap and which is defined by the stand 40. (See FIG. 4) The position along the z axis of the fixture is determined by two notches 244 formed in the guides that have a width that fits over the trunnion bearings 220 on opposite sides of the lineal path of travel. No special tools are need for either of the fixtures 210, 230. The user lifts an existing fixture out of the way, obtains an appropriate next fixture from a stock or inventory of such fixtures and slips it into place by placing a support axle 214 into the trunnion 220 or slipping the fixture into a position defined by the notch 244.

Film Guides

As depicted most clearly in FIGS. 8 and 9, the film F is routed from the supply roll 70 to the takeup roll 72 and through the transfer zone by elongated guide shafts 250, 252 properly angled and positioned with respect to the roller 62. Before the roller 62 is moved radially into contact with the film, these shafts 250, 252 guide the film F in a path through the transfer zone. An entrance guide shaft 250 is positioned to divert the film F in its path from the supply roll and route the backing B to the second or exit guide shaft 252. During set up of the workstation, a user or operator positions the guide shafts by proper positioning of three clamps 254, 256, 258 that are supported by an appropriate one of the two rings 74a, 74b. Proper set up results in the film passing along a path that is generally parallel to the surface which the decorative layer of the film F is designed to treat once the lineal is pushed into the transfer zone.

As the lineal 20 approaches the transfer zone, the motor 124 is actuated to bring the roller into engagement with the film, which allows the lineal 20 to be driven simultaneously with the foil. Once the film is trapped between the roller 62 and the lineal the frictional engagement causes the film to unwind from the supply. As the lineal moves through the transfers region, the take up roll 72 is rotated by a motor 260 coupled to a spindle 262 that supports the take-up roll. The spindle 262 supports an elongated clamp 263 extending along its length to allow an end of the backing layer B to be secured to the shaft or spindle 262 and hand wound a sufficient amount to connect the film to the take up roll. When not being rotated by the motor 260 a spring tensioner 264 maintains tension in the backing material.

Sensors

A controller 300 (FIG. 12) at the control station 14 monitors a number of different sensor inputs and controls a status of a number of different motors during operation of the system 10. Multiple optical sensors 302, 304, 306 are mounted to a fence 310 for monitoring a presence or absence of a lineal at the transfer zone. Other sensors monitor the temperature of a heater supported within the oven 132 and the temperature of the roll 62. During startup of the treatment of a succession of multiple lineals, a user or operator inserts a first lineal into a first workstation such as the station 12a. The appropriate position of the lineal is clear to the user due to the presence of a fixture having a gap to accept the lineal. No motive force is applied to the lineal until the head is moved into engagement with the lineal. The first two sensors or switches 302, 304 signal the controller when the lineal moves into the transfer zone 200. The sensors or switches 302, 304 are located on the infeed side of the station and the switch 306 is on the exit side. One switch 302 causes the controller to bring in a horizontal roller clamp 308 into contact with the lineal prior to the lineal entering the heated roller zone. A second switch 304 brings the heated roller down to make contact with the lineal. Once the lineal moves forward through the transfer zone, its presence will trip the third switch 306 which will bring in a second horizontal roller clamp 309 into contact with the side of the lineal to keep its movement stable as it exits the machine. Once the trailing end of the profile passes the switch 302 and the second switch 304 the 1 ^{st} clamp and the heated roller will retract. When the trailing end passes the third switch 306, the roller clamp 309 is retracted. The horizontal clamps 308, 309 are only used when there are no custom backing fixtures in place at the station.

Successive lineals are maintained in abutting relation as they are placed in succession into the first workstation 12a. Retraction of the head that rotates the roller 62 occurs when it is determined that a trailing edge of the lineal has passes a third sensor 306 and no lineal is sensed by the sensor 302.

The oven has resistance heaters mounted in its walls that when energized with appropriate voltages reach a temperature of up to 1100 degrees F. These heating elements radiate heat toward the roller 62 and more particularly cause the roller to reach a temperature of from 450 to 600 degrees F. Thermocouple sensors inside the oven monitor the temperature of the heating elements. An IR sensor 320 mounted to the outside of the oven monitors the temperature of the roller 62 to maintain the roller at a set point temperature or temperature range and further to prevent damage to the roller due to overheating. The controller 300 modulates activation of the heating elements to cause the sensed temperature of the roller to be maintained at or near a target temperature. The heating elements supported within the oven are commercially available heating elements obtained from Watlow Electric of St. Louis, Mo. In one embodiment, the system 10 includes a width monitoring ultrasonic sensor commercially available from Banner as part number S18UUARQ to warn a user when the film F is not an appropriate width for the lineal surface being treated or covered.

In the illustrated system a window or door lineal is typically extruded vinyl and may includes a center or middle channel/track used to support a window sash or door assembly. However, the component or lineal as now defined and used throughout both the specification and claims, also includes any size or shape window, door, or part forming the window, door, or supporting track assembly, including but not limited to, stiles, rails, tracks, frames, jambs, headers, sills, and channels on both interior and exterior sides of the window or door without departing from the spirit and scope of the claimed disclosure. In addition, the material composition forming the component is not limited to vinyl, but could be any type of material, including without limitation, metal, plastic, fiberglass, polymeric composition, or naturally existing material. Further the surface of the component could be cleaned or treated, for example with a sealant or painted prior to use by an applicator assembly constructed in any of the example embodiments of the present disclosure. It is within the spirit of the present claimed disclosure that the numerous uses of the term “component or lineal”, whether in singular or plural form throughout the various example embodiments of applicator assemblies herein embrace the full scope of the aforementioned definition.

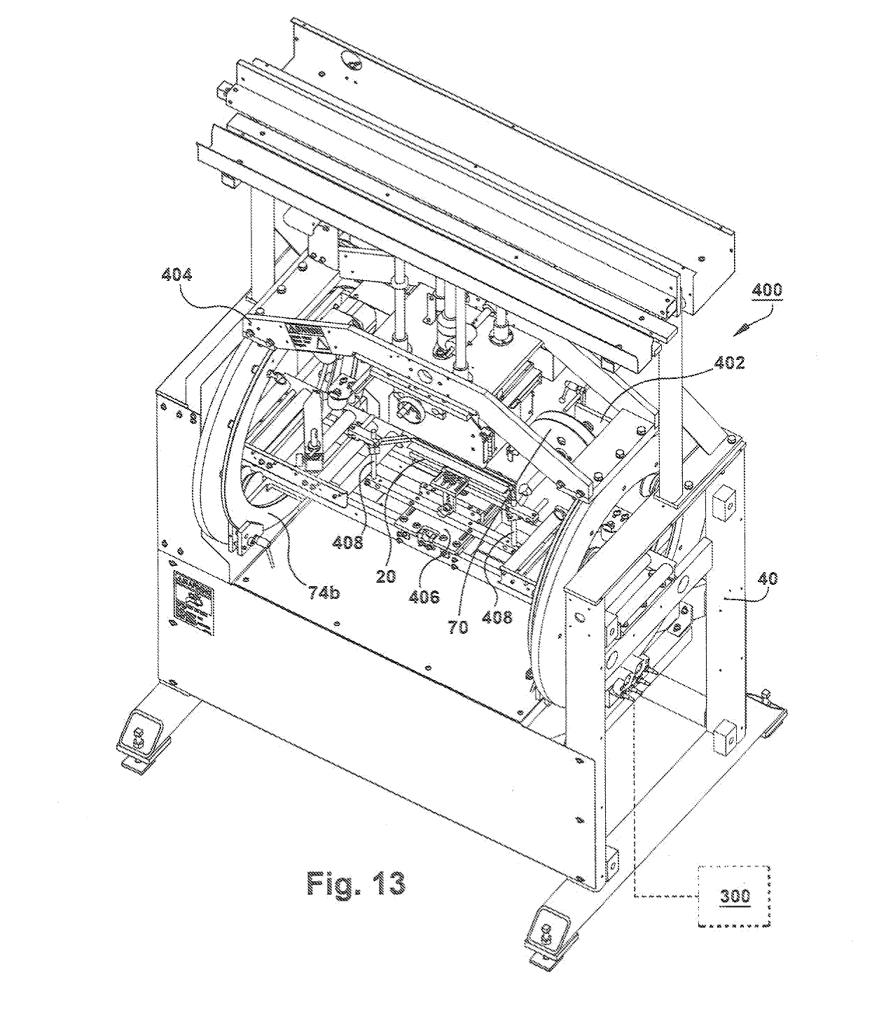

Referring now to FIG. 13 is a perspective view of an apparatus or system 400 for applying a decorative material, such as film “F” to at least one surface of a component 20 in accordance with one example embodiment of the present disclosure. The component 20 is a shortened length of one or two feet in the illustrated embodiment for purposes of clarity. However, it should be appreciated that the component can come in any length in excess of twenty (20) feet without departing from the spirit and scope of the present disclosure.

The apparatus 400 comprises a fixture 40 supporting a supply roll 70 and a take-up roll 72 fixedly attached to respective first and second fixtures 402, 404, respectively. The fixtures are coupled to rotatable first and second positioners 74a, 74b. The first and second positioners 74a and 74b are in communication with a controller 300 for adjusting the dispensing roll and take-up roll relative locations to a prescribed position. The apparatus 400 also comprises an interchangeable support fixture 405 for guiding successive components 20 and decorative material F during operation along a path of travel. The support fixture 406 comprises at least one guide member 408 fixedly attached to a surface of the support fixture. The guide member 408 includes at least one limb 410 comprising multiple degrees of selectable freedom for directing the passage of decorative material F onto a component 20 during operation.

The apparatus 400 advantageously reduces set-up time over for different profile components 20 significantly. For example, the embodiment illustrated in FIGS. 5 and 8, included several clamps 254, 256, 258, with adjustments and extensions that were adjustably coupled to the supply and take-up roll fixtures. For each component profile 20, the various clamps 254, 256, and 258 were used for all component profiles requiring tedious maneuvering, adjustments, and trials to before the clamps were properly located for decorative material application and tape removal. Film guidance and removal paths for the tape T and decorative material F for each component is unique, requiring a specific set-up of the clamps for each component 20. Such set-up would take a significant amount of time, up to several hours and was not repeatable between changes in component 20 profiles.

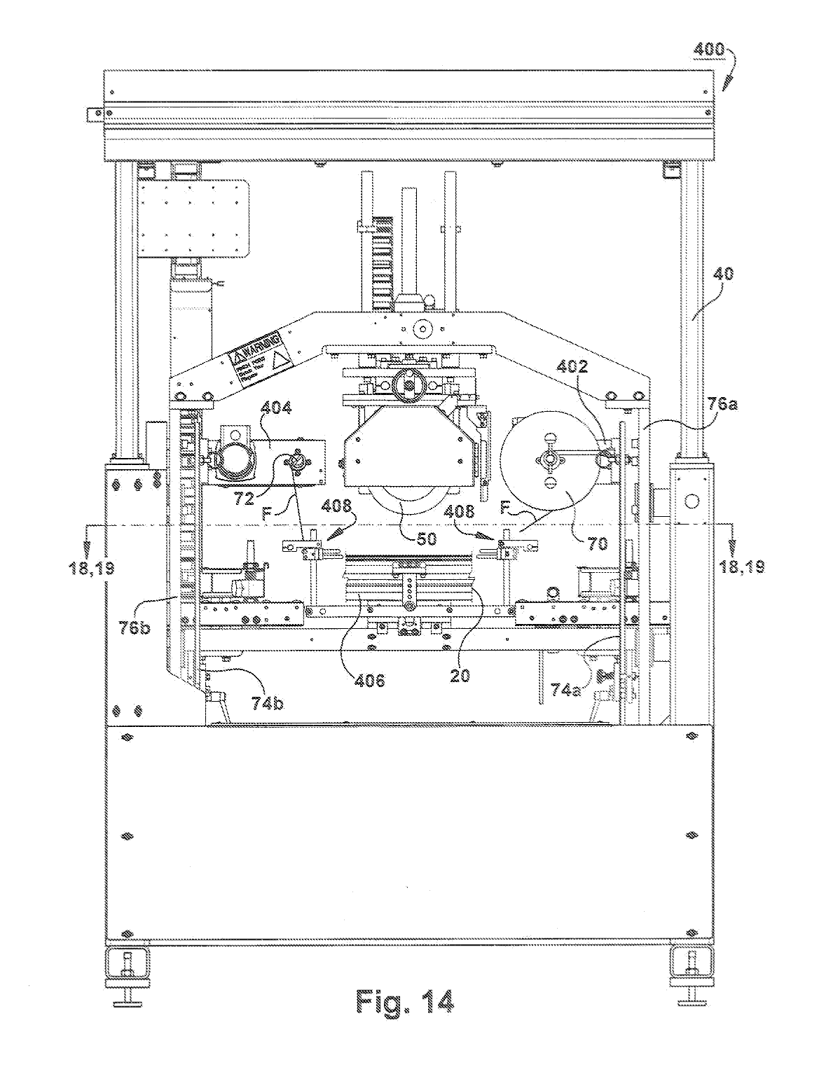

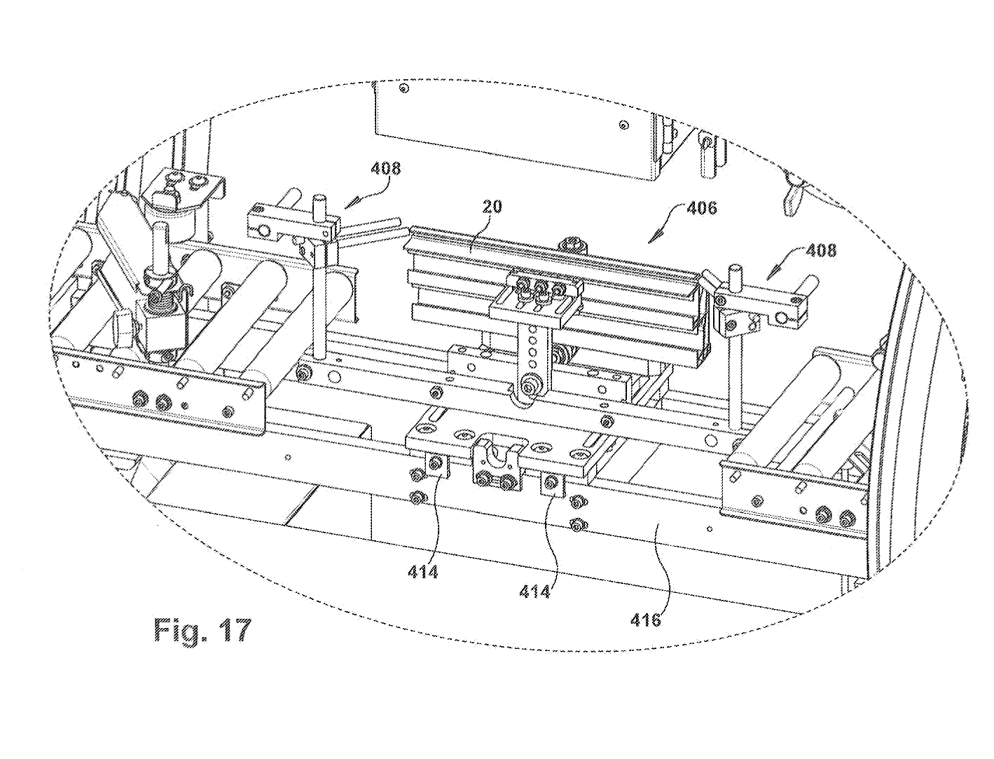

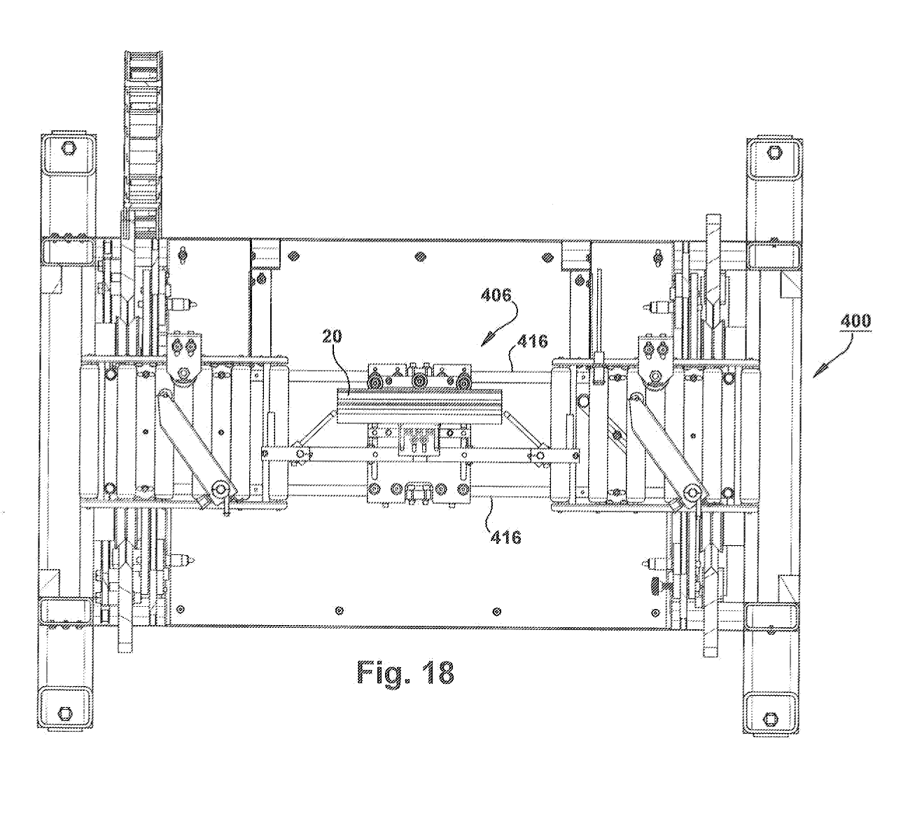

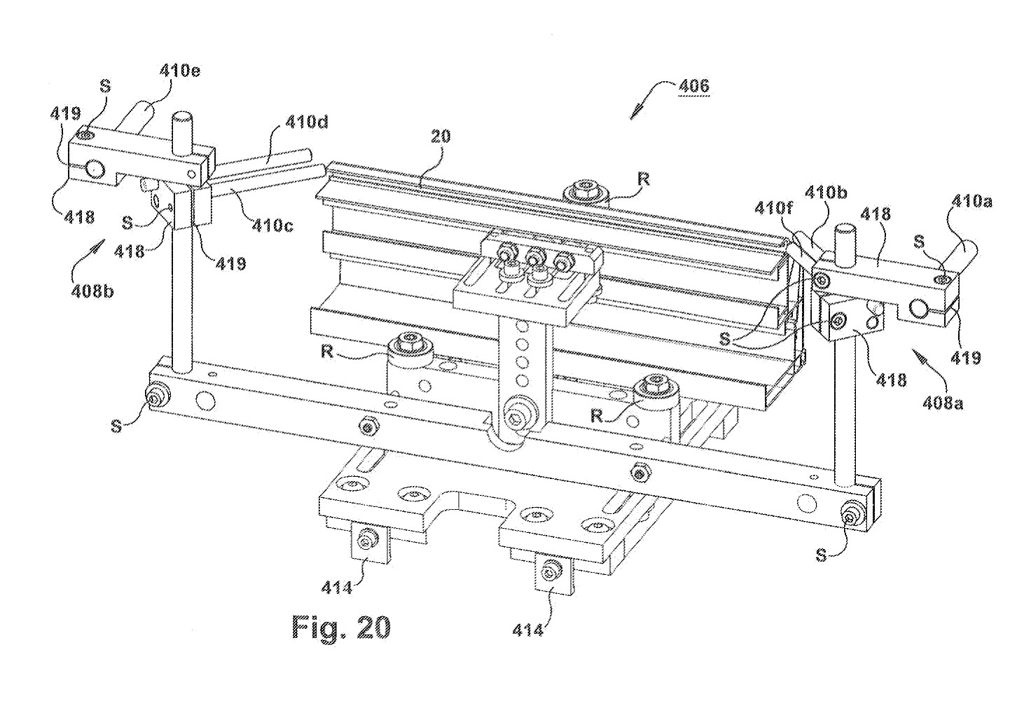

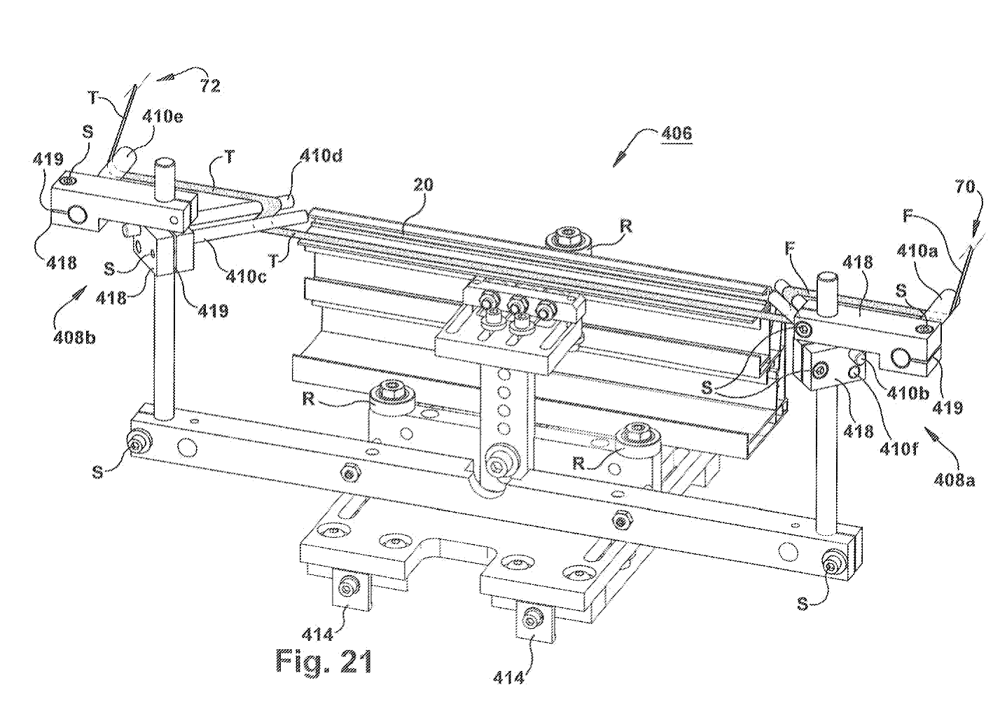

The adjustable clamps 254, 256, and 258 located on the roll 70, 72 fixtures, have been removed and replaced with various interchangeable support fixtures 406 as illustrated in the example embodiments of FIGS. 13-24. The support fixtures 406 advantageously include fixed guide members 408 extending from the fixture. The fixed guide members 408 include one or more limbs 410 that support and guide the decorative material F as it is applied to the components 20. The fixed guide members 408 also assist in the removal of the tape T once the decorative material F is applied to the component. The tape is collected on the take-up roll 72. The application of the decorative material F and tape T removal on a component 20 and various passages through guide members' limbs 410a-410f is illustrated in the example embodiment of FIGS. 20 and 21.

Each component 20 is assigned or associated with an interchangeable support fixture 406, wherein the guide members 408 that once located in an original or first set-up are securely held into position with fasteners or screws “S”, avoiding the time and need for set-up between different component profiles as required in the embodiments of FIGS. 5 and 8. The support fixture 406 also includes dedicated rollers “R” for holding and supporting the component 20 as it passes through the application system 10. In the illustrated example embodiments of FIGS. 20 and 21, the limbs 410 are cylindrical rods turned from metal bar stock and held by a locking fixture 418 that may include one or more limbs 410. The locking fixtures 418 include a corresponding opening for the limbs 410 with a split 419, that allows the fixture to clamp down on the limb by a screw S. The multiple locking fixtures 418 allow for multiple degrees of freedom between limbs 410 and about the x, y, and z axis, as would be appreciated by those skilled in the art. The interchangeable support fixtures 406 can be easily inserted into and removed from the apparatus 10 within a minute or less.

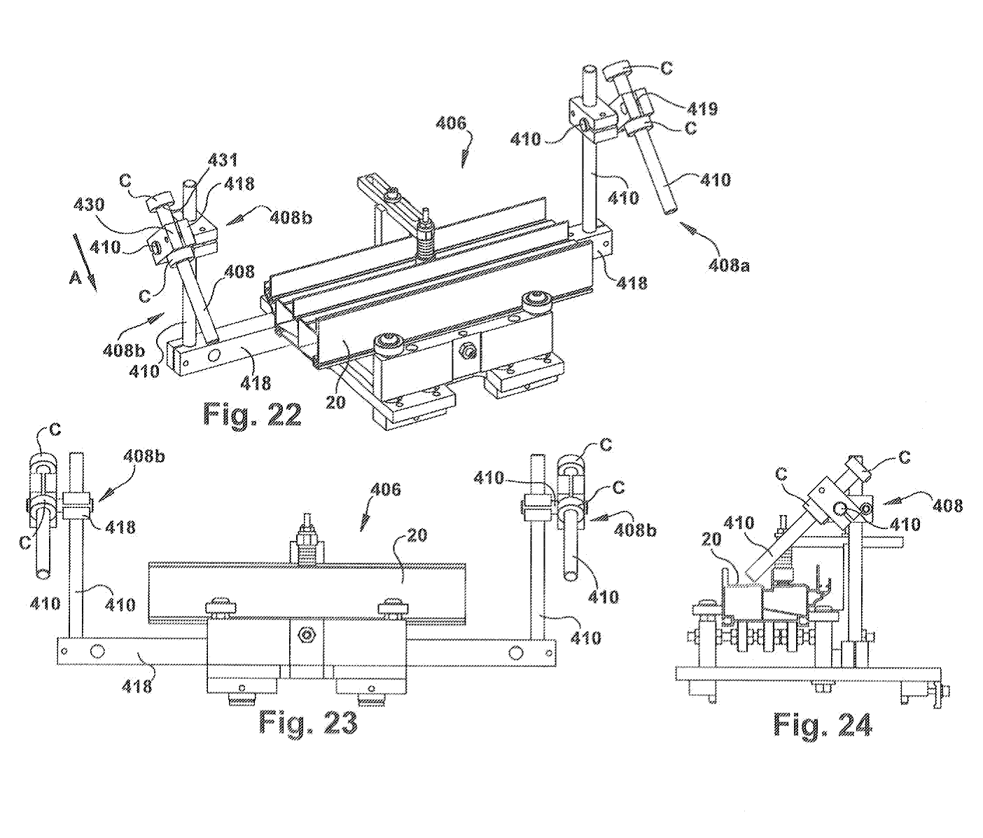

In the illustrated embodiment of FIGS. 22-24, the limbs 410 further comprise collars C to a to allow for quick change of different positions of the guide fixtures 408 for use with different component 20 profiles, eliminating the need to switch support fixture 406, while minimizing any set-up time. For example, switching from the current component 20 profile in FIG. 22 to a new component profile requires at guide member 408b only a loosening of screw S 430 and the advancement of limb 410q until collar C engages locking fixture 418 at collar front 431. This process may or may not need repeating at guide member 408a. It should be appreciate that this quick change eliminates the need to change out an entire support fixture 406, while minimizing any set-up time requirements.

During operation, the apparatus or system 400 elects one of an unlimited number of component 20 profiles for the application of the decorative material F. Once the profile is elected, the controller 300 identifies on an interface or user operated menu 450 the associated support fixture 406, and positions of the first and second positioners 74a, 74b, and first and second superior first and superior second positioners 76a, 76b based on a recipe or program within the controller 300. In one example embodiment, the controller 300 includes one or more processors and the recipe is read by non-transient computer readable media 440.

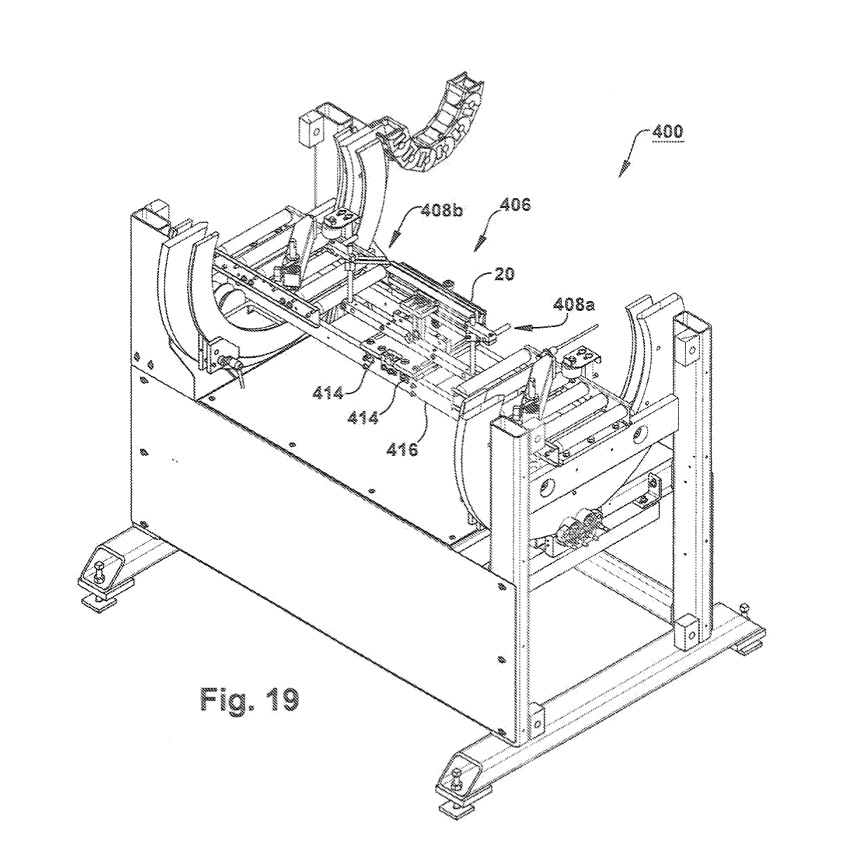

Once the particular support fixture 406 having the pre-set guide members 408 for applying decorative material F to the component 20 profile is identified, the support fixture is positioned on locating rails 415 (see FIG. 19) via locking tabs 414 located on the front and rear of the support fixture. The locking tabs 414 allow for quick insertion and removal of the support fixture 406.

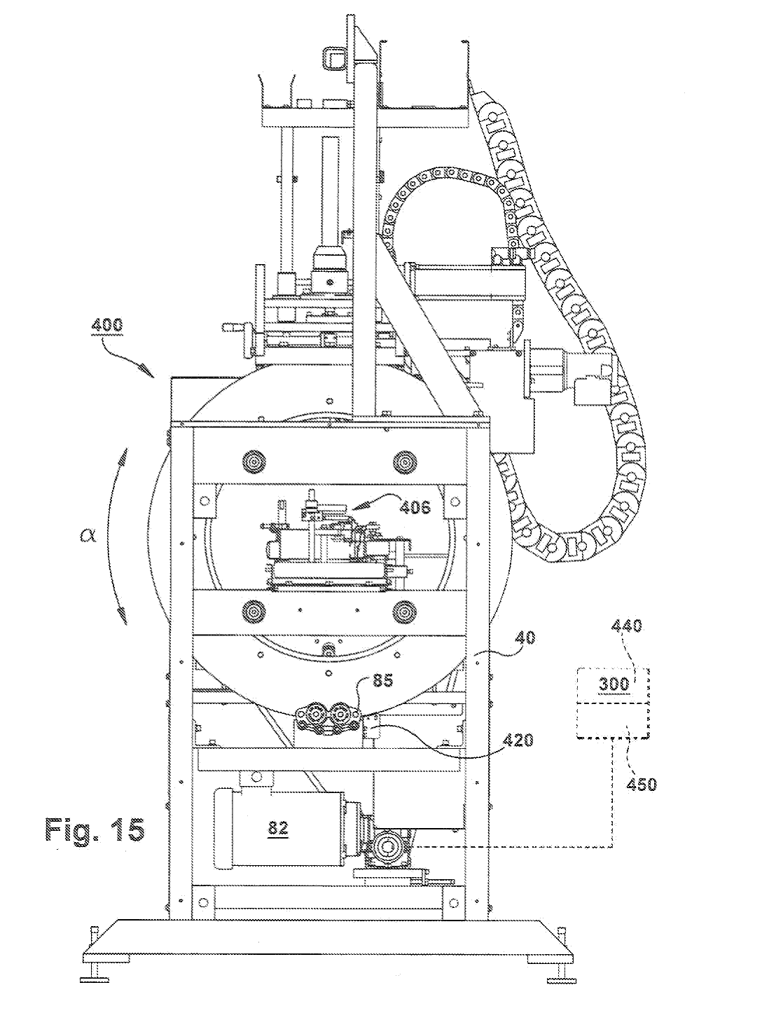

Once the fixture 406 is located and locked onto the rails 416, the controller 300 drives the first and second positioners 74, and superior positioners 76 rotationally relative to the fixture 40 via the electric motor 82 as indicated by arrows α illustrated in FIG. 15. The controller 300 and electric motor 82 include an encoder or analyzer 420 to selectively position the positioners 74, 76 to their prescribed positioned associated with the elected component 20 as identified in the menu 450 program 440.

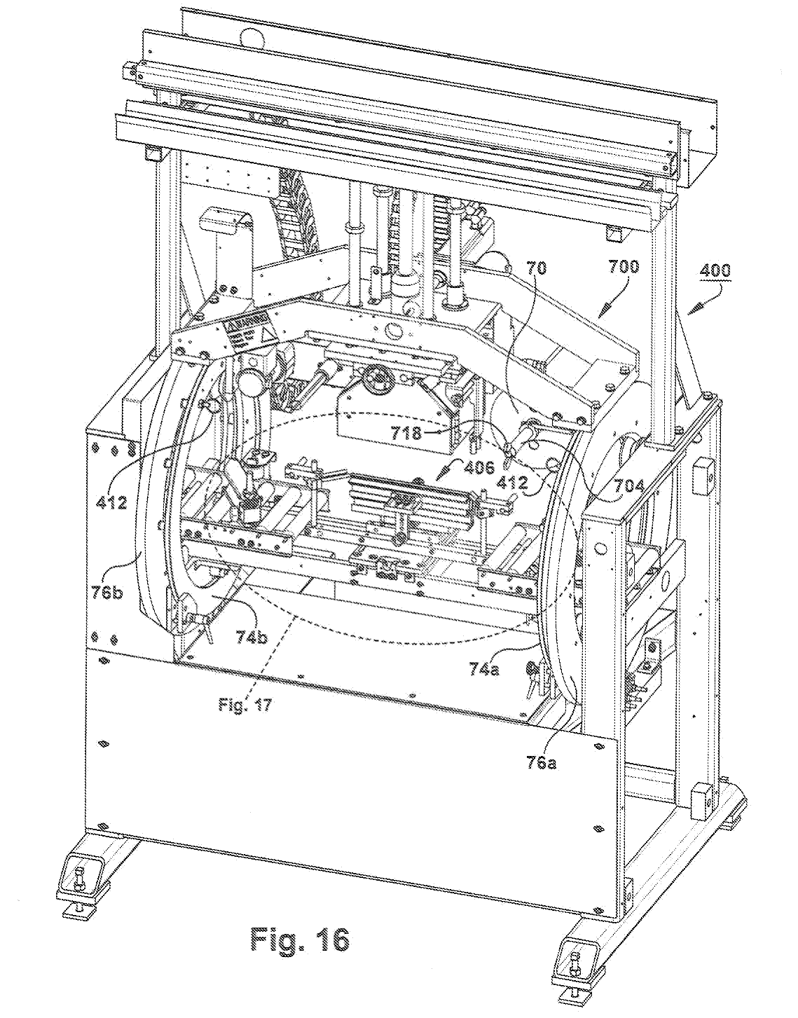

Once the desired location for the first and second positioners 74a, 74b is reached, the rotation by the motor 82 is temporarily ceased. The position of the supply roll 70 and take-up roll 72 are in the desired angular position based on the menu 450 recipe 440 corresponding to the elected component 20. A link 412, as illustrated in FIG. 16 that couples the positioners 74 with the superior positioners 75 is removed. A stop or brake 85 is then applied, holding the first and second positioners 74a and 74b in an applying position. Once the brake 85 is applied to positioners 74, the motor 82 is reengaged to rotate superior first and second positioners 76a, 76b to the desired relative dispensing location of the drive roller 50 based on the menu 450 recipe 440 and feedback value provided by the encoder 420. In the illustrated example embodiment, the link 412 is a spring or pull pin.

Once the desired location for the superior first and second positioners 76a, 76b is reached, the tape is loaded on the supply roll fixture 402 and fed through support fixture 406, and specifically the guide members 408a and 408b as illustrated in the example embodiment of FIG. 21. The apparatus 10 is then operated as described above for the application of decorative material F to the elected component 20.

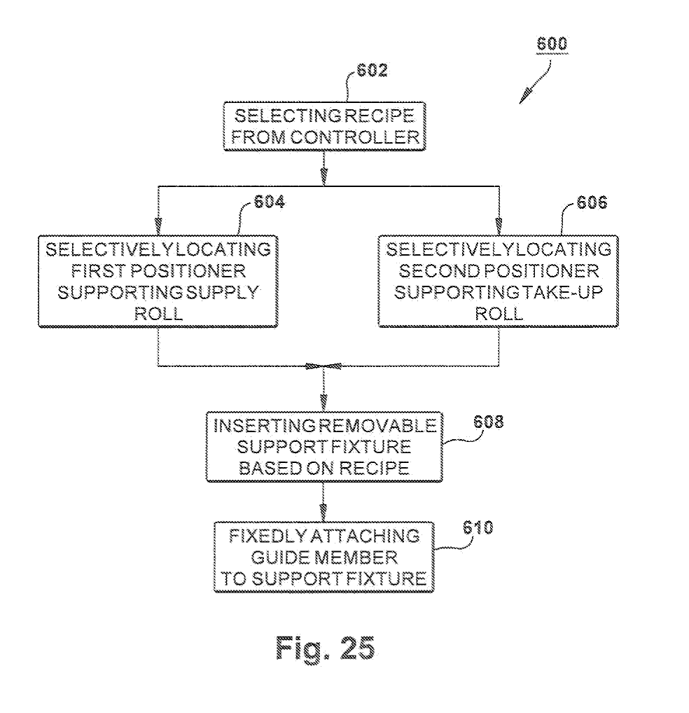

FIG. 25 is a block diagram illustrating a method 600 for applying decorative material F to a component 20 in accordance with one example embodiment of the present disclosure. The method 600 at 602 includes selecting a recipe 440 from a controller 300 based on the profile or type of component 20 receiving the application of decorative material during operation. The method 600 at 604 and 606 comprises the step of selectively locating a supply roll 70 coupled to a first rotational positioner 74a and selectively locating a take-up roll 72 coupled to a second rotational positioned 74b based on the recipe 440 stored in the controller 300. In the illustrated example embodiment of FIG. 16, the take-up roll 72 is an axle or shaft that is rotated by an independent motor at the same pace as the rotation of the supply roll 70, allowing for the accumulation of the backing tape after the application of the film F to the element 20.

The method 600 at 608 also includes the step of inserting a removable support fixture 406 based on the recipe 440. The support fixture guides successive components 20 and decorative material F during operation along a path of travel. At 610, the method 600 comprises the step of fixedly attaching at least one guide member 408 to a surface of the support fixture 406, the guide member having at least one limb 410 comprising multiple degrees of selectable freedom for directing the passage of decorative material onto a component during operation.

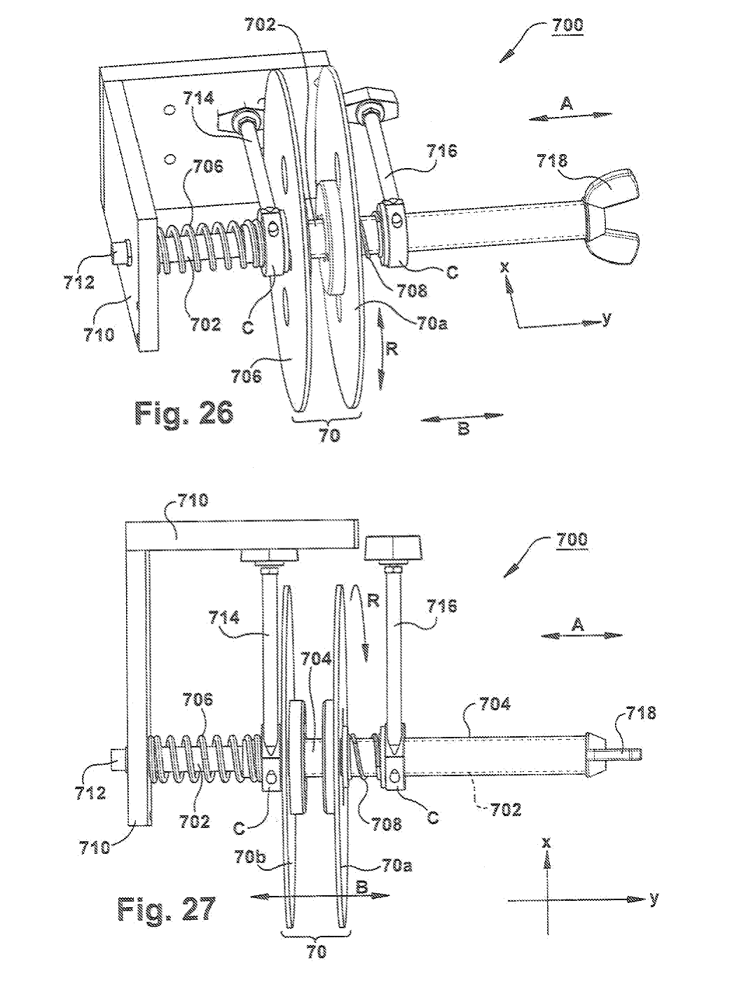

Referring now to FIGS. 16, 26, and 27 are various views of a supply assembly 700 constructed in accordance with one example embodiment of the present disclosure. The supply assembly 700 comprises the supply roll 70, supporting decorative material or film F. The supply assembly 700 further comprises an adjustment rod 702 that passes through the assembly and supply roll 70 and an adjustment sleeve 704. In one example embodiment, the adjustment rod 702 is a threaded rod. The supply roll 70 includes first and second supply reels 70a, and 70b, both laterally fixed to the adjustment sleeve 704, but capable of rotational movement relative to the sleeve as indicated by arrows R. The reels 70a and 70b include respective bushings, allowing for the rotational movement R relative to the sleeve 704.

The supply assembly 700 also comprises first and second biasing members 706 and 708, respectively. In the illustrated example embodiment, biasing members 706 and 708 include a coil or an extension spring, but could be other mechanical structures that provide a resistance load against the supply roll 70. The adjustment rod 702 passes through the biasing members 706 and 708, while the adjustment sleeve 704 passes through only the second biasing member. The first biasing member 706 controls the relative location of the supply roll 70 along the y-axis for selectable alignment with the type of component 20 profile receiving film F. While the second biasing member 708 controls the rotational tension of the supply roll 70 between reels 70a and 70b.

The supply assembly 700 is supported by fixture 710 that is a part of the first fixture 402 and assembly fixture 40. The adjustment rod 702 at a first end is locked into position by a fastener 712 and supported across the assembly by adjustable arms 714 and 716. An adjustable nut 718 is selectively adjusted along the y axis as indicated by arrows A, allowing for the relative positioning and lateral movement of the supply roll 70 and sleeve 704 along the adjustment rod 702 as indicated by arrows B. In the illustrated example embodiment, rotation of the adjustable nut 718 engages the adjustment sleeve 704 about which the supply roll 70 is rotationally fixed, and such adjustment of the nut results in the linearly positioning of the supply roll and adjustment sleeve in a selectable range of 1-3″ inches along the y-axis.

The above construction of the supply assembly 700 advantageously allows the supply roll 70, film F, and adjustable sleeve 704 to move to a selected and desired location along the adjustable rod 702 during operation of the machine. This avoids long delays and reduces/eliminates setup time associated with typical equipment, while adding for the flexible and precise placement of the film F relative to the support fixture 406 and component 20 positioning. Such positioning of the supply roll 70 via the supply assembly 700 allows for the proper alignment of the film F between different component 20 profiles and support fixtures 406.

During operation, the turning of the adjustable nut 718 results in the linear displacement of the adjustable sleeve 704 and supply roll 70 axially against the control facilitated by the biasing members 706, 708. The adjustable sleeve 704 can be translated along the adjustment rod 702 in the direction of the y-axis, but will not rotate based on a keying or anti-rotational mechanism as would be appreciated by those skilled in the art. Adjustable arms 714 and 716 move along the fixture 710 during selected adjustment, and collars “C” maintain pressure against the biasing member 708 and proper distance between reels 70a and 70b that form the supply roll 70. Each reel, 70a and 70b possesses internal bushings, allowing for their rotation (see arrows R) about adjustable sleeve 704.

The exemplary system has been described with a degree of particularity. It is the intent, however, the invention include all modifications and alternations from the disclosed design falling within the spirit or scope of the appended claims.

1. Apparatus for applying a decorative material to at least one surface of a component, the component can then be cut and assembled to form part of a window or door, the apparatus comprising:
a supply roll and a take-up roll fixedly attached to respective first and second fixtures, the fixtures being coupled to first and second positioners, said first and second positioners are in communication with a controller for adjusting the dispensing roll and take-up roll relative locations to a prescribed position; and
a support fixture for guiding successive components and decorative material during operation along a path of travel, said support fixture comprising at least one guide member fixedly attached to a surface of said support fixture, said guide member having at least one limb comprising multiple degrees of selectable freedom for directing the passage of decorative material onto a component during operation.

2. The apparatus of claim 1 wherein said apparatus further comprises an analyzer that communicates the relative position of the first and second positioners to the controller.

3. The apparatus of claim 1 wherein said at least one limb and guide member are securely attached to said support fixture to provide for repeatable application of decorative material during operation.

4. The apparatus of claim 1 wherein said apparatus further comprises a transfer head for applying heat and pressure to the decorative material during operation, the transfer head being coupled to superior first and superior second positioners, said superior first and superior second positioners are in communication with said controller for adjusting the transfer head location to a prescribed position.

5. The apparatus of claim 4 wherein said apparatus further comprises an analyzer that communicates the relative position of the first positioner, second positioner, superior first positioner, and superior second positioner.

6. The apparatus of claim 4 further comprising a link selectively coupling at least one of said first and second positioners with at least one of said superior first and superior second positioners.

7. The apparatus of claim 5 wherein said apparatus further comprises a drive for moving successive components during operation along a path of travel through the application station from the input side to the output side as the decorative material is applied to a surface of a component during operation.

8. The apparatus of claim 1 wherein said controller further comprises executable nontransient computer readable media for controlling the relative location of said first and second positioners and superior first and superior second positioners with respect to a designation on said support fixture identifying the profile of a component to travel along a path of travel during operation, thus orienting the desired prescribed relative locations of said transfer head, supply roll, and take-up roll.

9. The apparatus of claim 8 wherein said executable nontransient computer readable media for controlling the relative location of said first and second positioners and superior first and superior second positioners further comprises a menu for selecting one of a plurality of said designations identifying different profiles of the components assigned to each support fixture during operation.

10. The apparatus of claim 1 additionally comprising a brake for fixing an orientation of the first and second positioners with respect to a component travel path during operation.

11. The apparatus of claim 10 wherein the controller includes a memory for storing a recipe for multiple component shapes wherein the controller positions the transfer head via superior first and superior second positioners and reels via first and second positioners at different positions with respect to a component path of travel through said apparatus.

12. The apparatus of claim 11 wherein said apparatus further comprises a plurality of apparatuses forming a multiple application station for applying decorative material to different surfaces of a component during operation, said controller having said menu for storing a recipe for said multiple application station, the menu for positioning the transfer heads via superior first and superior second positioners and reels via first and second positioners at different positions with respect to a component path of travel in each station in said apparatuses.

13. A system for applying decorative material to at least one surface of component used in the assembly of a window or door, the system comprising:
a supply roll and a take-up roll fixedly attached to respective first and second fixtures, the fixtures being coupled to first and second positioners, said first and second positioners are in communication with a controller for adjusting the dispensing roll and take-up roll relative locations to a prescribed position;
a transfer head for applying heat and pressure to the decorative material during operation, the transfer head being coupled to superior first and superior second positioners, said superior first and superior second positioners are in communication with said controller for adjusting the transfer head location to a prescribed position;
at least one of the the first and second positioners being selectively connected to at least one of said superior first and superior second positioners by a link; and
an interchangeable a support fixture for guiding successive components and decorative material during operation along a path of travel, said support fixture comprising at least one guide member fixedly attached to a surface of said support fixture, said guide member having at least one limb comprising multiple degrees of selectable freedom for directing the passage of decorative material onto a component during operation.

14. The system of claim 13 further comprising an encoder that communicates the independent rotatable positions of the first and second positioners and first superior and second superior positioners to the controller.

15. The system of claim 13 where said at least one limb and guide member are securely attached by fasteners to said support fixture to provide for repeatable application of decorative material during operation.

16. The system of claim 13 further comprising a drive for moving successive components during operation along a path of travel through the application station from the input side to the output side as the decorative material is applied to a surface of a component during operation.

17. The system of claim 13 wherein said controller further comprises executable nontransient computer readable media for controlling the relative location of said first and second positioners and superior first and superior second positioners with respect to a designation on said support fixture identifying the profile of a component to travel along a path of travel during operation, thus orienting the desired prescribed relative locations of said transfer head, supply roll, and take-up roll.

18. The system of claim 17 wherein said executable nontransient computer readable media for for controlling the relative location of said first and second positioners and superior first and superior second positioners further comprises a menu for selecting one of a plurality of said designations identifying different profiles of the components assigned to each support fixture during operation.

19. The system of claim 18 wherein the controller includes a memory for storing a recipe for multiple component shapes wherein the controller positions the transfer head via superior first and superior second positioners and reels via first and second positioners at different positions with respect to a component path of travel through said apparatus.

20. A method of applying decorative material to a component used in to make windows and/or door assemblies, the method comprising the steps of:
selecting a recipe from a controller based on the profile or type of component receiving the application of decorative material during operation;
selectively locating a supply roll coupled to a first rotational positioner and selectively locating a take-up roll coupled to a second rotational positioner based on said recipe stored in said controller;
inserting a removable support fixture based on said recipe, the support fixture for guiding successive components and decorative material during operation along a path of travel; and
fixedly attaching at least one guide member to a surface of said support fixture, said guide member having at least one limb comprising multiple degrees of selectable freedom for directing the passage of decorative material onto a component during operation.

21. A supply assembly for selectively locating the application of decorative material to a component used in to make windows and/or door arrangements as the components move along a path of travel corresponding to a first direction, the supply assembly comprising:
a supply roll comprising first and second supply reels rotatably located on an adjustment sleeve, the supply roll for supporting decorative material applied in line along said first direction and onto a window or door arrangement during operation;
an adjustment rod passing through said adjustment sleeve and supply roll reels, the adjustment rod having a selectively rotatable nut at a first end of said adjustment rod that engages said adjustment sleeve for the selectable location of said supply roll and adjustment sleeve to a desired position along a second direction; and
a biasing member enveloping a second end of said adjustment rod, the biasing member controlling the selectable location of the supply roll and adjustment sleeve along the second direction for selectable alignment of the supply roll's dispensing of decorative material applied to a window or door arrangement during operation.

22. The supply assembly of claim 21 wherein said biasing member engages at least one of said first and second reels forming said supply roll.

23. The supply assembly of claim 22 further comprising at least one locatable arm having an adjustable collar for supporting said adjustable rod, the locatable arm having first and second sides, wherein said first side is engaged by said biasing member and said second side engaged by one of said first and second reels.
